(19) United States
(12) Patent Application Publication
(10) Pub. No.: US 2005/0017411 A1
(43) Pub. Date: Jan. 27, 2005

(54) Three-dimensional shaping apparatus and method using non-contact type heating tool

(76) Inventors: Dong Yol Yang, Seo-gu (KR); Hyo Chan Kim, Jeonju-si (KR); Sang Ho Lee, Yuseong-gu (KR); Dong Gyu Ahn, Dong-gu (KR)

Correspondence Address: GRAYBEAL, JACKSON, HALEY LLP, 155 - 108TH AVENUE NE, SUITE 350, BELLEVUE, WA, 98004-5901, US

(21) Appl. No.: 10/888,427

(22) Filed: Jul. 9, 2004

(30) Foreign Application Priority Data
Jul. 11, 2003 (KR) 2003-47255

(51) Int. Cl. B29C 35/00

(52) U.S. Cl. 264/319; 425/174; 425/383

(57) ABSTRACT

Disclosed herein is a three-dimensional (3-D) shaping apparatus and method using a non-contact type heating tool. The 3-D shaping apparatus includes three feeding units, an indexing table and a non-contact type heating tool. The feeding units move in three different directions perpendicular to each other. The indexing table includes a support frame provided with support arms uprightly extending, a seating member hinged to the support arms, and a fixing chuck rotatably combined with the seating member and adapted to grip one side of a soft material. The seating member is placed to be rotated around one of the three moving directions of the three units, and the fixing chuck is placed to be rotated around a rotating axis perpendicular to a rotating axis of the seating member. The non-contact type heating tool is mounted on one of the feeding units to shape soft material by thermally resolving the soft material without contact with the soft material.

### CROSS-REFERENCE TO RELATED APPLICATIONS

This application claims priority from Korean Patent Application No. 2003-47255 filed 11 Jul. 2003, which is incorporated herein by reference.

### BACKGROUND OF THE INVENTION

1. Field of the Invention

The present invention relates generally to a three-dimensional shaping apparatus that produces an elaborate shape using materials, such as thermoplastic/thermosetting resin and foam, or additionally produces the detailed shape of a first shaped object and, more particularly, to a three-dimensional shaping apparatus and method that are capable of quickly and accurately shaping a workpiece using a non-contact type heating apparatus and an indexing table.

2. Description of the Related Art

In a conventional shaped object manufacturing method using a three-dimensional (3-D) cutting method, a workpiece is manufactured in such a way that a shape obtained by Computer-Aided Design (CAD) is calculated into a two-dimensional (2-D) shape that can be produced by projecting the 3-D shape in various directions, the calculated 2-D shape is transferred to a heating wire and a foam block is passed through the heating wire in various directions. In this method, a rough shape is first produced, and then a more detailed shape is manually produced. However, this method is defective in that it is difficult to produce the shape of the 2-D heating wire and the dependency on manual working is excessively high.

For another conventional 3-D shape manufacturing method, there is a 3-D rapid manufacturing method using cutting and filling processes disclosed in Korean Unexamined Pat. No. 2002-32008. In this method, a table for fixing a workpiece is rotated to an angle of 180° or 900 or a random angle and a workpiece is shaped in each of the positions. This method is defective in that it is easy to shape the side surfaces of the workpiece but it is difficult to shape the upper and lower surfaces thereof.

In the meantime, a foam shaping method using a heating wire is disclosed in Korean Unexamined Pat. Publication No. 2003-4638. This method is an intermittent material supply type variable layer rapid shaping method using a linear heat cutting system. In this method, data on unit inclined shape layers are produced by slicing a 3-D CAD model, the unit inclined shape layers are produced while intermittently supplying a plate material and cutting the plate material using a 4 degree-of-freedom linear heat cutting system, and a 3-D shape is produced by combining the unit inclined shape layers. This method can achieve a maximum precision using the heating wire. Since a 3-D shape is obtained by combining shaped layers each having a predetermined thickness, this method has limitations in the manufacture of a detailed shape and a 3-D shape.

Korean Unexamined Pat. Publication 1999-74740 discloses a five-axis free-formed surface shaping method. Instead of using conventional five-axis control, a three-axis shaping apparatus and a two-axis tilting table are used to shape free-formed surfaces. This method reduces the manufacturing costs of five-axis shaped surfaces, but makes it difficult to produce the paths of a three-axis shaping tool based on the positions of the two-axis tilting table. Accordingly, this method allows the paths of the tool to be produced with respect to the four positions of the workpiece. It is difficult to apply the two-axis tilting table manually set up and tiled at a random angle to general processes because it is inefficient and restrictive.

### SUMMARY OF THE INVENTION

Accordingly, the present invention has been made keeping in mind the above problems occurring in the prior art, and an object of the present invention is to provide a 3-D shaping apparatus and method using a non-contact type heating tool, which is capable of shaping the upper and lower surfaces of a workpiece and does not produce chips as a by a by-product.

In order to accomplish the above object, the present invention provides a three-dimensional (3-D) shaping apparatus for forming a three-dimensional shape on a workpiece, comprising: a feeding unit for moving the workpiece in three different directions perpendicular to each other; an indexing table including a support frame having support arms extended uprightly, a seating member hingedly fixed to the support arms, and a fixing chuck rotatably combined with the seating member and adapted to grip one side of the workpiece, the seating member being placed to be rotated around one of the three directions in which the leading unit moves, the fixing chuck being placed to be rotated around a rotating axis perpendicular to a rotating axis of the seating member; and a non-contact type heating tool mounted on one of the feeding unit for thermally resolving the workpiece to form the three-dimensional shape thereon without contact with the workpiece.

In addition, the present invention provides a 3-D shaping method using the 3-D shaping apparatus of claim 1, comprising: a side surface shaping step including the steps of (a) fixing the workpiece to the fixing chuck, (b) rotating the indexing table to allow a side surface of the workpiece to be placed in a feed region of the non-contact type heating tool, (c) downwardly moving the non-contact type heating tool, (d) shaping the side surface of the workpiece, (e) upwardly moving the non-contact type heating tool, and (f) repeating the step (c) to (e) until all side surfaces of the workpiece being shaped; and the plane surface shaping step including the steps of (g) rotating the indexing table to allow an upper surface of the workpiece to be placed in the feed region of the non-contact type heating tool, (h) downwardly moving the non-contact type heating tool and shaping the upper surface of the workpiece.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a perspective view showing the use of a 3-D shaping apparatus using a non-contact type heating tool according to an embodiment of the present invention;

FIG. 2 is a perspective view showing the indexing table of the 3-D shaping apparatus of FIG. 1 in detail;

FIG. 3a is a plan view showing the vacuum chuck of the 3-D shaping apparatus of FIG. 1 in detail;

FIG. 3b is a perspective view showing the seating member of the 3-D shaping apparatus of FIG. 1 in detail;

FIG. 3c is a sectional view showing the vacuum chuck of FIG. 3a and the seating member of FIG. 3b that are combined with each other;

FIG. 4 is a sectional view showing the heating tool of the 3-D shaping apparatus of FIG. 1 in detail; and

FIG. 5 is a flowchart showing a 3-D shaping method according to an embodiment of the present invention.

### DESCRIPTION OF THE PREFERRED EMBODIMENTS

Reference now should be made to the drawings, in which the same reference numerals are used throughout the different drawings to designate the same or similar components.

An embodiment of the present invention is described in detail with reference to exemplary drawings below.

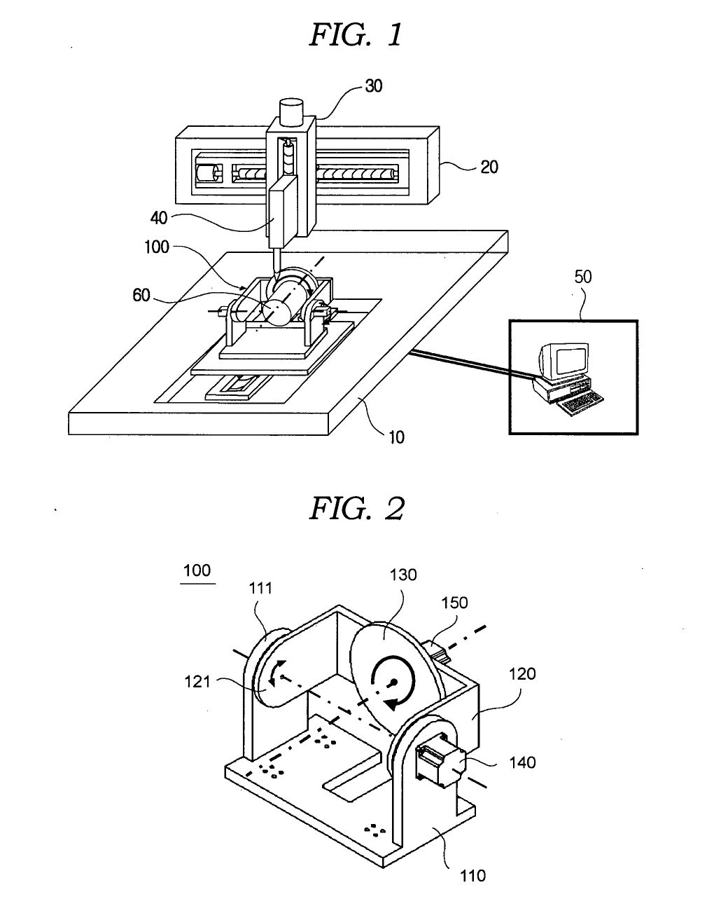

FIG. 1 is a perspective view showing the use of a 3-D shaping apparatus using a non-contact type heating tool according to an embodiment of the present invention. A feed means includes a first feeding unit 10, a second feeding unit 20 and a third feeding unit 30.

An indexing table 100 to which a workpiece 60 is fixed is seated on the first feeding unit 10. The first feeding unit 10 functions to move the indexing table 100 in a horizontal direction (X-axis direction). The second feeding unit 20 is placed at a location vertically spaced apart from the first feeding unit 10, and functions to horizontally move the third feeding unit 30 in the direction (Y-axis direction) perpendicular to the feed direction of the first feeding unit 10. The third feeding unit 30 is mounted on the second feeding unit 20, and moves in the direction (Z-axis direction) perpendicular to the feed direction of the second feeding unit 30. A vise 40 is combined with the third feeding unit 30. A heating tool, which will be described later, includes the vise 40.

The vise 40 moves in the direction perpendicular to the feed direction of the first feeding unit 10 on a horizontal plane, or moves downwardly toward the first feeding unit 10 depending on the movement of the first or second feeding unit 20 and 30. Accordingly, the vise 40 of the heating tool is assured a feed region along an X-axis direction by the first feeding unit 10 that feeds the indexing table 100, and is assured feed regions along Y- and Z-axis directions by the second and third feeding units 20 and 30. Accordingly, the 3-D shaping apparatus of the present invention has a 3-D feed region around the workpiece 60 fixed to the indexing table 100.

The feeding units 10, 20 and 30 and the indexing table 100 move along predetermined paths under the control of a control unit 50 connected thereto in a wired or wireless manner.

Meanwhile, although in the present embodiment, there has been described the case where 3-axis working is performed in such a way that the vise 40 of the heating tool is moved by the second and third feeding units 20 and 30 in both Y-axis and Z-axis directions and the indexing table 100 is moved by the first feeding unit 10 in the X-axis direction, it is possible to fixedly place the indexing table 100 at a separate location and locate the vise 40 in the feed regions along X-, Y- and Z-axis directions.

FIG. 2 is a perspective view showing the indexing table of the 3-D shaping apparatus of FIG. 1 in detail. The indexing table 100 includes a support frame 110, a seating member 120 and a vacuum chuck 130.

The support frame 110 is attached to the first feeding unit 10, and support arms 111 extend upright from both sides of the support frame 110, respectively. The seating member 120 is hinged to the support arms 111 to be rotated around coupling shafts. The seating member 120 is bent at both sides thereof to be easily coupled to the support arms 111. The vacuum chuck 130 is attached to the center of the seating member 120.

A first motor 140 and a second motor 150 are mounted on one of the support arms 111 and the seating member 120 to rotate the seating member 120 and the vacuum chuck 130, respectively. The workpiece 60 is fixed to the seating member 120 through the medium of the vacuum chuck 130. The workpiece 60 is rotated within an angular range of 0° to 3600 by the second motor 150 around the Y-axis, and rotated around the X-axis by the first motor 140.

Therefore, when the workpiece 60 is rotated to a predetermined angle by the second motor 150, one side surface of the workpiece 60 is located in the feed region of the heating tool and the side surface of the workpiece 60 can be shaped. Furthermore, when the seating member 120 is rotated clockwise by the first motor 140, the upper or bottom surface of the workpiece 60 enters the feed region of the heating tool and the upper or bottom surface of the workpiece 60 can be shaped.

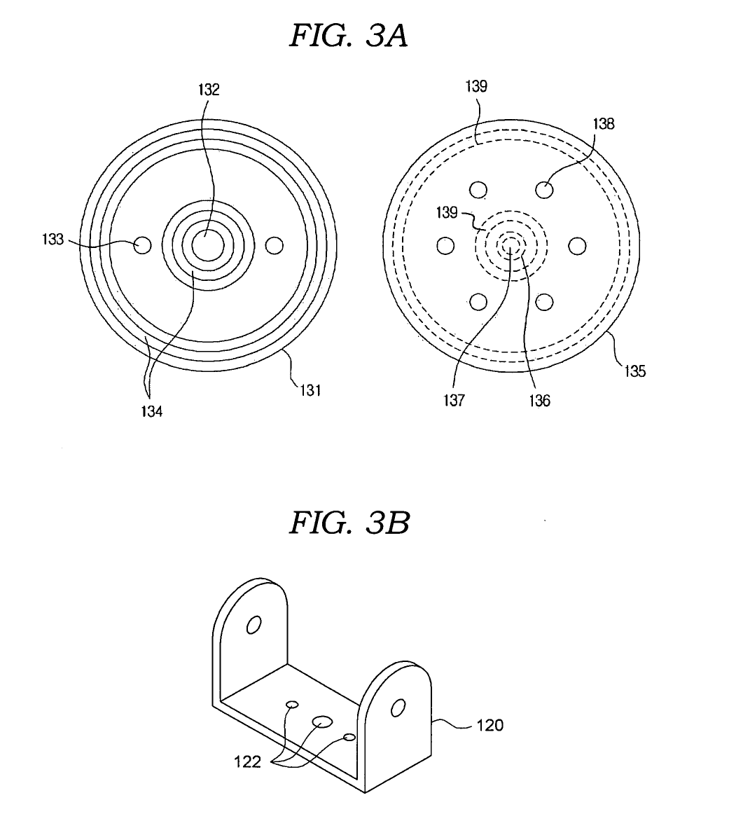

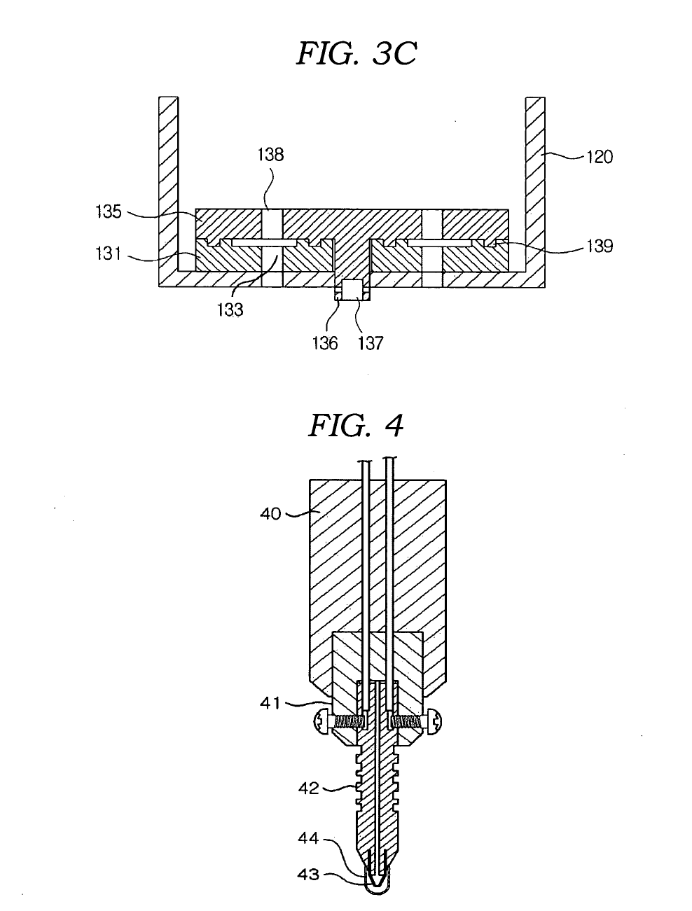

The workpiece 60 is fixed by the vacuum chuck 130 in a suction manner. The structures of the vacuum chuck 130 and the seating member 120 are illustrated in FIGS. 3a and 3b, respectively.

The vacuum chuck 130 is fabricated by combining a disk-shaped fixed plate 131 and a rotating 135 engaged with the fixed plate 131. The fixed plate 131 is attached to the seating 120 and is connected to a vacuum pump (not shown). A shaft hole 132 and two communicating holes 133 are formed through the fixed plate 131, and two circular fitting grooves 134 are formed outside the shaft hole 132 and the communicating holes 133, respectively.

The rotating plate 135 comes into contact with the workpiece 60 and supports the workpiece 60. A plurality of suction holes 138 are formed through the rotating plate 135, and a boss 136 passed through and fitted into the shaft hole 132 and circular protrusions 134 fitted into the fitting grooves 134 of the fixed plate 131 are formed on the rear surface of the fixed plate 131. In this case, the fitting grooves 134 of the fixed plate 131 and the circular protrusions 139 of the rotating plate 135 are smoothly finished to minimize frictional resistance between the contact surfaces thereof. Furthermore, a shaft hole 137 is formed through the boss 136 and is fitted over the drive shaft of the second motor 150 mounted on the seating member 120.

As shown in FIG. 3b, three coupling holes 122 are formed through the seating member 120, to which the fixed plate 131 is attached, to be aligned with the communicating holes 133 of the fixed plate 131 and the boss 136 of the rotating plate 135, respectively.

FIG. 3c is a sectional view of the fixed plate 131, the rotating plate 135 and the seating member 120 that are combined together. Referring to this drawing, the circular protrusions 139 of the rotating plate 135 are fitted into the fitting grooves 134 of the fixed plate 131, and the boss 136 provided with the shaft hole 137 is projected outside the seating member 120 through the shaft hole 132 of the fixed plate 131.

A predetermined space exists between each of the communicating holes 133 connected to the vacuum pump and each of the attraction holes 138 used to fix the workpiece 60, and functions to transmit suction force, which is generated through the communicating holes 133, to the plurality of suction holes 138.

With the vacuum chuck 130, the workpiece 60 can be fixed to the rotating plate 135 via the fixed plate 131 connected to the vacuum pump, and can be rotated by the rotating plate 135 connected to the second motor 150. In this case, the fixed plate 131 is fixed to the seating member 120 and is not rotated, and air flowing through the communicating holes 133 and the suction holes 138 is prevented from leaking to the outside by the fitting of the fitting grooves 134 over the circular protrusions 139.

The vacuum chuck 130 constructed as described above firmly holds the upper or lower surface of the workpiece 60 in a suction manner using the vacuum pump in a suction manner, unlike the conventional device that fixes the workpiece 60 by holding the workpiece 60 using jaws, so that any flaw does not remain on the surface of the workpiece 60.

FIG. 4 is a sectional view showing the heating tool of FIG. 1 in detail. Referring to this drawing, a support 42 is combined with the vise 40 attached to the third feeding unit 30 through an insulation member 41, and a heating wire 43 is attached to the support 42.

The support 42 combined with the insulation member 41 is made of an electrical conductor, such as copper, and is composed of two separate bodies so that it is connected to a power supply (not shown) with the two bodies independently connected to the positive and negative terminals of the power supply. The separated bodies of the support 42 are electrically connected to each other by the heating wire 43 that is an electrical resistor. In the present embodiment, Ni—Cr is employed as the material of the heating wire 43.

When current is supplied to the support 42 through the power supply, the current flows through the heating wire 43 connecting the two bodies of the support 42. The heating wire 43 is made of metallic material capable of conducting electricity, but has considerably high electrical resistance because it is formed in a shape having a small cross section and a large length. Accordingly, as the current flows through the heating wire 43, the heating wire 43 radiates more heat. The temperature of the heating wire 43 is increased to about 700° C., and can sufficiently transmit heat to an object spaced apart from the heating wire 43 by a considerable distance. Hence, when the heating wire 43 is allowed to approach a workpiece made of foam, the workpiece is thermally resolved by thermal energy irradiated from the heating wire 43 and thus shaped.

When the heating tool capable of shaping the workpiece without contact with the workpiece is employed, the precision of shaping can be increased due to the absence of cutting resistance, and thus the shaping speed of the workpiece can be improved. Furthermore, with the heating tool, the workpiece is thermally resolved by the heat irradiated from the heating wire 43, so that the heating tool does not produce chips, unlike a conventional cutting tool, thus making a working environment comfortable. Meanwhile, to realize a more comfortable working environment, an air suction unit is preferably mounted on the one side of the vise 40 of the heating tool or the indexing table 100. The air suction unit functions to draw odor or gas that is generated when the workpiece is shaped by the heating tool.

In the heating tool, the temperature of heat irradiated from the heating wire 43 varies according to the intensity of current supplied from the power supply. Using this phenomenon, a shaping width and depth can be regulated.

$$\begin{matrix}η = A * {Q}_{eff}^{h} + B & ( 1 ) \\ {Q}_{eff}^{h} = \frac{{Q}_{eff}}{H * {V}_{c}} & ( 2 )\end{matrix}$$

In Equation 1, η is a shaping width, A and B are constants, and Q^{h}_{eff} is effective heat capacity per unit height. In Equation 2, Q_{eff}, which is a process variable of the present invention, is effective heat capacity, H is the distance between a tool and a workpiece, and V_{c} is shaping speed. These three variables Q_{eff}, H and V_{c} can be expressed in terms of Q^{k}_{eff} that is a combination variable. Equation 1 represents relations obtained through experiments. With these linear relations, the value of Q^{h}_{eff} required to obtain a desired shaping depth η can be obtained. A desired shaping width can be easily obtained by calculating an appropriate process variable from Equation 2 using the obtained Q^{h}_{eff} and applying the obtained appropriate process variable to the process.

In the present invention, a cap 44 is worn on the tip of the heating wire 43 that significantly influences the magnitude of energy reached from the heating tool to the workpiece. The cap 44 functions both to protect the heating wire 43 and to allow the heat to be uniformly irradiated around the cap 44. Meanwhile, the shape of the workpiece can be varied by changing the shape of the cap 44.

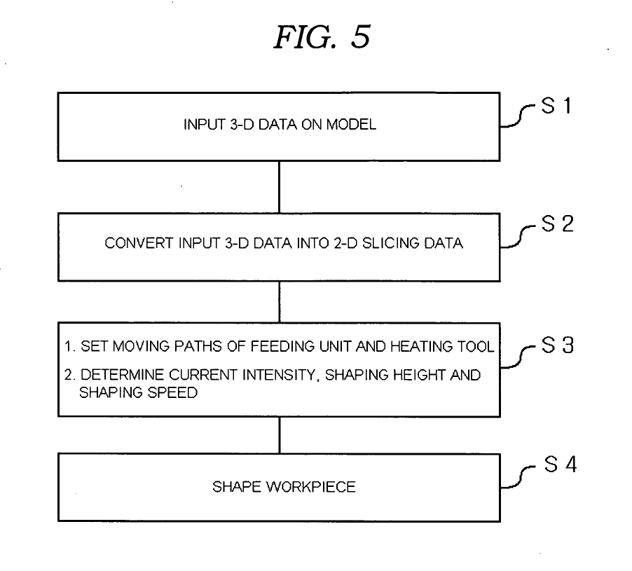

FIG. 5 is a flowchart schematically showing a 3-D shaping method according to an embodiment of the present invention.

The first step S1 is to input 3-D CAD data to the data unit of the control unit 50, which allows data on a model formed in 3-D through modeling to be stored in the control unit 50. In this case, since the design of the 3-D model is performed through a 3-D modeling program, data are input after being converted into data in a file format, such as Design Web Format (DWF), that is commonly used.

The second step S2 is to convert the input 3-D CAD data into 2-D slicing data. Since the conventional 3-D shaping is performed by repeatedly performing 2-D shaping, it is difficult to set the shaping paths of a tool using only the input 3-D data. Accordingly, it is necessary to convert the input 3-D data into the combination of 2-D data that allow the shaping paths of the tool to be easily produced.

2-D slicing is a method of converting a 3-D shape into the combination of a plurality of sections, which represent paths along which the tool moves to shape a workpiece. In the present invention, the workpiece is rotated and the surfaces of the workpiece are independently shaped, so that the 2-D slicing is performed times, whose number corresponds to the number of surfaces to be shaped.

The third step S3 is to determine the moving paths of the heating tool according to the 2-D slicing data formed at the second step S2, the amount of heat generated in the heating tool and the moving speed of the heating tool. At this step, the paths of the heating tool (in X- and Y-directions) are set for each slicing to implement the shapes represented by the 2-D slicing data. After the moving paths are set, the intensity of current applied to the heating wire, the moving speed of the heating tool and the distance between the heating tool and the workpiece using the above-described two equations in view of the shaping widths depending on the moving paths are calculated.

In the meantime, since the shaping of the workpiece is not performed on a single surface of the workpiece but performed on five surfaces, the working paths of the heating tool are partially overlapped. Accordingly, in the present invention, new 2-D slicing data capable of minimizing the moving paths of the heating tool are produced by comparing the slicing data formed with respect to the surfaces of the workpiece to be shaped and deleting the overlapped paths of the heating tool.

The fourth step S4 is to shape the surfaces of the workpiece based on the data determined at the third step S3. The workpiece is fixed to the fixing chuck. Thereafter, the heating tool is moved along the set paths and shapes the workpiece. After one surface of the workpiece has been shaped, the fixing chuck is rotated and another surface of the workpiece is shaped. This operation is repeated until four surfaces of the workpiece are shaped. After the four surfaces of the workpiece have been shaped, the indexing table is rotated and the upper surface of the workpiece is shaped, thus achieving a 3-D shape.

When it is desired to shape all the six surfaces of a workpiece, a 3-D shape is achieved by cutting the workpiece into halves, shaping the five surfaces of each half and bonding the halves at the unshaped surfaces thereof. However, this scheme is limited to the case where the vacuum chuck requiring sucking surfaces is employed. Accordingly, when the fixing chuck other than the vacuum chuck is employed, the workpiece is shaped in such a way that five surfaces of the workpiece are shaped, the workpiece is held by the fixing chuck to allow the unshaped surface of the workpiece to face to the outside, and then the unshaped surface of the workpiece is shaped.

As described above, the present invention provides the 3-D shaping apparatus, which is capable of shaping the upper and lower surfaces of a workpiece so that it can shape a workpiece in various forms and can reduce shaping time, and which allows a workpiece to be shaped using the heating tool so that chips are prevented from being produced during shaping, thus providing a comfortable working environment.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A three-dimensional (3-D) shaping apparatus for forming a three-dimensional shape on a workpiece, comprising:
a feeding unit for moving the workpiece in three different directions perpendicular to each other;
an indexing table including a support frame having support arms extended uprightly, a seating member hingedly fixed to the support arms, and a fixing chuck rotatably combined with the seating member and adapted to grip one side of the workpiece, the seating member being placed to be rotated around one of the three directions in which the leading unit moves, the fixing chuck being placed to be rotated around a rotating axis perpendicular to a rotating axis of the seating member; and
a non-contact type heating tool mounted on one of the feeding unit for thermally resolving the workpiece to form the three-dimensional shape thereon without contact with the workpiece.

2. The 3-D shaping apparatus of claim 1, wherein the fixing chuck is an air suction type fixing chuck.

3. The 3-D shaping apparatus of claim 1, further comprising an air suction unit mounted on a side of the non-contact type heating tool to eliminate odor and gas generated during the shaping of the workpiece.

4. The 3-D shaping apparatus of claim 1, wherein the non-contact type heating tool has a vise combined with one of the feeding unit, a support combined with the vise and includes two bodies that are separated from each other and connected to positive and negative terminals of a power supply unit, a heating wire attached to the support, and a cap attached to the support to be worn cover the heating wire.

5. A 3-D shaping method using the 3-D shaping apparatus of claim 1, comprising:
a side surface shaping step including the steps of (a) fixing the workpiece to the fixing chuck, (b) rotating the indexing table to allow a side surface of the workpiece to be placed in a feed region of the non-contact type heating tool, (c) downwardly moving the non-contact type heating tool, (d) shaping the side surface of the workpiece, (e) upwardly moving the non-contact type heating tool, and (f) repeating the step (c) to (e) until all side surfaces of the workpiece being shaped; and
the plane surface shaping step including the steps of (g) rotating the indexing table to allow an upper surface of the workpiece to be placed in the feed region of the non-contact type heating tool, (h) downwardly moving the non-contact type heating tool and shaping the upper surface of the workpiece.
